(19) United States
(12) Patent Application Publication
(10) Pub. No.: US 2014/0253226 A1
(43) Pub. Date: Sep. 11, 2014

(54) POWER INTEGRITY CONTROL THROUGH ACTIVE CURRENT PROFILE MANAGEMENT

(71) Applicant: LSI CORPORATION, San Jose, CA (US)

(72) Inventors: Ting Zhou, Orinda, CA (US); Ruggero Castagnetti, Menlo Park, CA (US); Chris Sonnek, Centerville, MN (US)

(73) Assignee: LSI CORPORATION, San Jose, CA (US)

(21) Appl. No.: 13/800,120

(22) Filed: Mar. 13, 2013

Related U.S. Application Data
(60) Provisional application No. 61/772,644, filed on Mar. 5, 2013.

(51) Int. Cl. G05F 1/10

(52) U.S. Cl. CPC G05F 1/10
USPC 327/538

(57) ABSTRACT

An apparatus having one or more of a plurality of circuits in a first level of a hierarchy and two or more of the circuits in a second level of the hierarchy is disclosed. The circuits are configured to (i) allocate a profile from the first level down to the second level, (ii) manage from the second level a respective power consumed by each of a plurality of blocks based on the profile and (iii) maintain a sum of the powers approximately constant by increasing the power consumed by a first of the blocks while decreasing the power consumed by a second of the blocks.

### FIELD OF THE INVENTION

Embodiments of the invention relate to power management generally and, more particularly, to a method and/or apparatus for implementing power integrity control through active current profile management.

### BACKGROUND

As networking system-on-a-chip throughput demands increase, more circuitry is integrated into chips. The increased size of the circuitry brings significant power integrity challenges. Parts of the chips could be switching between a high-current consumption mode and a low-current consumption mode rapidly and randomly, which produces large current surges. Typically power integrity designs guard against a worst case scenario by adding on-chip or on-package decoupling capacitors. Due to an unpredictable nature of the current surges, two worst case scenarios are commonly encountered. In particular, some current surges have large frequency content that is close to a packaging resonance frequency. Furthermore, some current surges occur when blocks go into high activity or low activity modes for a period of time.

### SUMMARY

Embodiments of the invention concern an apparatus having one or more of a plurality of circuits in a first level of a hierarchy and two or more of the circuits in a second level of the hierarchy. The circuits are configured to (i) allocate a profile from the first level down to the second level, (ii) manage from the second level the respective power consumed by each of a plurality of blocks based on the profile and (iii) maintain a sum of the powers approximately constant by increasing the power consumed by a first of the blocks while decreasing the power consumed by a second of the blocks.

### BRIEF DESCRIPTION OF THE FIGURES

Embodiments of the invention will be apparent from the following detailed description and the appended claims and drawings in which:

FIG. 1 is a block diagram of an embodiment of an apparatus;

FIG. 2 is a block diagram of an embodiment of an active current profile management circuit in accordance with an embodiment of the invention;

FIG. 3 is a flow diagram of an example method for adjusting a power consumption profile;

FIG. 4 is a block diagram of an example implementation of a local active current profile management circuit;

FIG. 5 is a block diagram of an example implementation of a sectional active current profile management circuit;

FIG. 6 is a flow diagram of another example method for adjusting a power consumption profile; and

FIG. 7 is a block diagram of an example implementation of a digital switching system.

### DETAILED DESCRIPTION

Embodiments of the invention include providing power integrity control through active current profile management that may (i) be implemented over a portion of a SOC, (ii) be implemented over all of the SOC, (iii) actively manage power (or current) consumption to reduce decoupling capacitance criteria, (iv) increase the overall power consumption and/or (v) be implemented in (on) an integrated circuit. In some embodiments, system-on a-chip (e.g., SOC) decoupling capacitance (e.g., DCAP) criterion is reduced by actively managing a portion of, or a whole current (or power) demand profile of the SOC. The active management comprises multiple levels of active current profile manager (e.g., ACPM) circuits in a hierarchical arrangement. The ACPM circuits communicate to one or more higher-level ACPM circuits and one or more lower-level ACPM circuits. Each lowest-level ACPM circuit is referred to as a local ACPM (e.g., LACPM) circuit. Each LACPM circuit actively manages a corresponding current profile for one or more circuits (or blocks) based on a current consumption target. The ACPM circuits at higher levels are referred to as sectional active current profile manager (e.g., SACPM) circuits. Each SACPM circuit aggregates current (or power) consumption information from one or more LACPM circuits and decides the current consumption target for each LACPM circuit based on a current consumption target received from a higher level SACPM circuit.

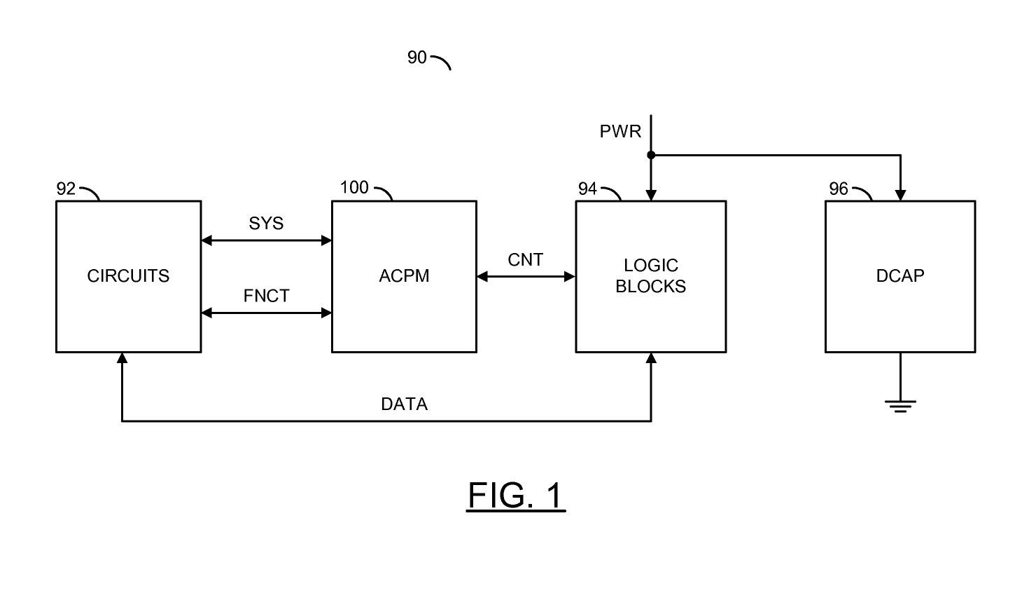

Referring to FIG. 1, a block diagram of an example implementation of an apparatus 90 is shown. The apparatus (or circuit or device or system-on-a-chip) 90 implements a circuit that provides power integrity control through active profile management. Some embodiments of the apparatus 90 may be implemented in a switch circuit of a digital network. The apparatus 90 comprises one or more blocks (or circuits) 92, multiple blocks (or circuits) 94, one or more blocks (or circuits) 96 and a block (or circuit) 100. The circuits 92 to 100 may represent modules and/or blocks that may be implemented as hardware, software, a combination of hardware and software, or other implementations. In some embodiments, the circuit 90 is fabricated in (on) an integrated circuit (or chip or die). In other embodiments, the circuit 90 is fabricated as one or more integrated circuits and associated packages.

A signal (e.g., SYS) is shown exchanged between the circuits 92 and the circuit 100. The signal SYS conveys system management information. A signal (e.g., FNCT) is shown exchanged between the circuits 92 and the circuit 100. The signal FNCT provides system functional information. A signal (e.g., CNT) is shown exchanged between the circuit 100 and the circuits 94. The signal CNT carries control and status information. The circuits 92 and 94 exchange a signal (e.g., DATA). The signal DATA conveys logic input data sent from the circuits 92 to the circuits 94 and logic output data sent from the circuits 94 to the circuits 92. Electrical power is shown presented to at least the circuits 94 and the circuits 96 via a signal (e.g., PWR).

Each circuit 92 implements one or more functional circuits. The circuits 92 are operational to perform various operations of the apparatus 90. In some embodiments, one or more of the circuits 92 are operational to perform switching operations in a digital network. Performance of the operations incorporates the functionality of one or more of the circuits 94. Other operations (or functions or processes) may be implemented to meet the criteria of a particular application.

Each circuit 94 implements one or more logic block circuits (or devices). The circuits 94 are operational to perform various logical operations. In some embodiments, one or more of the circuits 94 are implemented as content addressable memories (e.g., CAM). In other embodiments, one or more of the circuits 94 are implemented as ternary content addressable memories (e.g., TCAM). Other logical (or digital or boolean) operations may be implemented to meet the criteria of a particular application. The circuits 92 and the circuits 94 exchange input data and output data via the signal DATA. The circuits 92 provide input data to be worked in the one or more of the circuits 94 in the signal DATA. The corresponding circuits 94 operate on the input data to generate output data. The output data is returned to the circuits 92 in the signal DATA. The types of data transferred in the signal DATA are generally the types that have little to no effect on changing the power consumption of the circuit 94.

Each circuit 96 implements one or more decoupling capacitance (e.g., DCAP) circuits. The circuits 96 are operational to filter electrical power in the signal PWR. In some embodiments, the circuits 96 are fabricated in (on) the same integrated circuit as the circuits 92, 94 and 100. In other embodiments, the circuits 96 are fabricated as part of a package containing the circuits 92, and 100. In still other embodiments, the circuits 96 are fabricated apart from the circuitry and packaging and mounted in a circuit board near the packages. Combinations of the circuits 96 could be fabricated in some embodiments as part of the integrated circuits, part of the packages and/or mounted on the circuit board.

The circuit 100 implements multiple power management circuits. The circuit 100 is operational to provide power integrity control through active current profile management of the power in the signal PWR consumed by the circuits 94. The active profile management permits a size of the filtering capacitance provided by the circuits 96 to be reduced by modifying current profiles to reduce variations in current consumed by the circuits 94. In some embodiments, the circuit 100 is configured to allocate a profile from a higher level to a lower level in a hierarchy of circuits. The circuit 100 also manages from the lower level a respective power consumed by the circuits 94 based on the profile. The circuit 100 maintains a sum of the powers approximately constant by increasing the power consumed by an individual circuit while decreasing the power consumed by another individual circuit 94.

The circuits 92 and 100 exchange information through the signals SYS and FNCT. The signal SYS is used to provide controls having an appreciable effect the power consumption of the circuits 94. For example, the signal SYS can command a circuit 94 into a different mode, such as a memory power down mode. The signal FNCT is used for functions of the circuits 94 that have an appreciable effect on the power consumption of the circuit 94. For example, the signal FNCT can instruct a circuit 94 to initiate a search in a ternary content addressable memory.

The circuits 94 and 100 exchange information through the signal CNT. The signal CNT carries modified versions of the commands and functional instructions of the signals SYS and FNCT. The circuit 100 can modify the commands and functional instructions based on the current profile of the circuit 94. For example, the circuit 100 can instruct a circuit 94 to perform a search in the ternary content addressable memory to maintain a particular current profile when no search is requested in the signal FNCT.

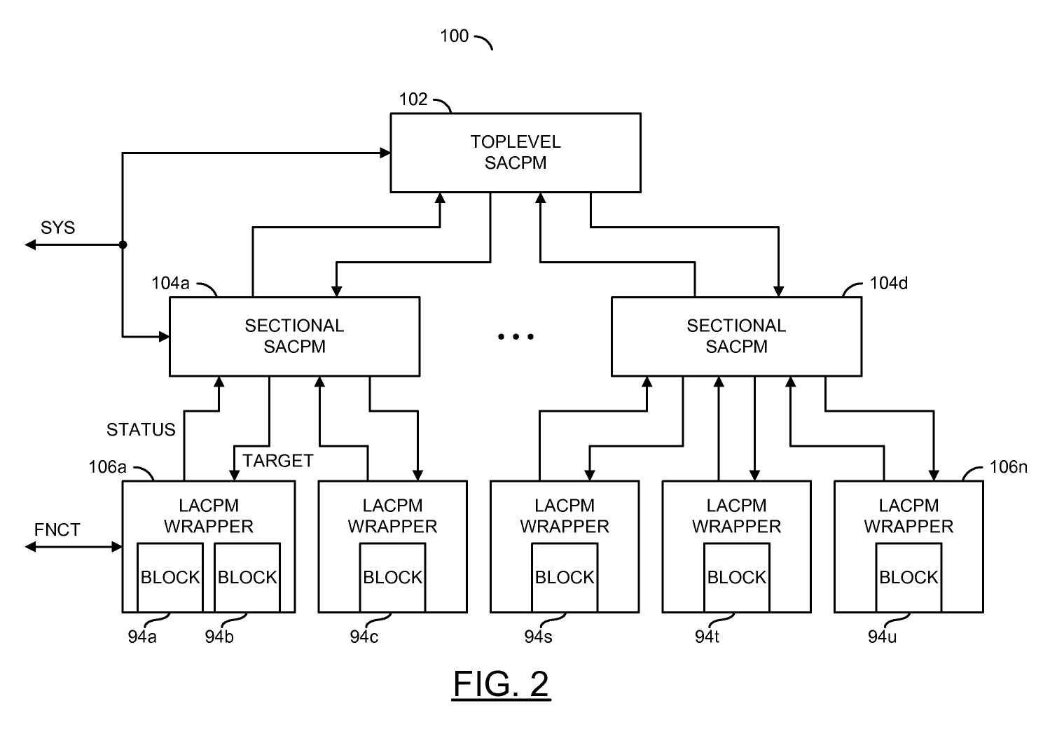

Referring to FIG. 2, a block diagram of an example implementation of the circuit 100 is shown in accordance with an embodiment of the invention. The circuit 100 comprises a block (or circuit) 102, multiple blocks (or circuits) 104a-104d and multiple blocks (or circuits) 106a-106n. The circuits 102 to 106n may represent modules and/or blocks that may be implemented as hardware, software, a combination of hardware and software, or other implementations. The circuits 94 of FIG. 1 are shown as individual circuits (or blocks) 94a-94u in FIG. 2. Each circuit 106a-106n provides a wrapper interface to one or more of the individual circuits 94a-94u.

In some embodiments, the circuits 102-106n are arranged in a multi-level (e.g., 3-level) hierarchy. The circuit 102 resides at a highest (or top) level of the hierarchy. The circuits 104a-104d reside at a middle (or intermediate) level of the hierarchy. The circuits 106a-106n reside at a lowest (or bottom) level of the hierarchy. Other numbers of levels (e.g., 2, 4, 5, etc.) in the hierarchy and other numbers of hierarchy circuits (e.g., circuits 102-106n) at each level may be implemented to meet the criteria of a particular application.

The signal SYS is shown sent and received by each of the ACPM circuits above the lowest level (e.g., the circuits 102 to 104d). The signal FNCT is shown sent and received by each of the ACPM circuits in the lowest level (e.g., the circuits 106a-106n). A signal (e.g., TARGET) is shown generated by each of the ACPM circuits above the lowest level and presented to another ACPM circuit at a next level down (e.g., from the circuit 104a down to the circuit 106a). The signal TARGET carries information concerning a target power budget or profile for each respective lower ACPM circuit. A signal (e.g., STATUS) is shown generated by each of the ACPM circuits below the highest level and presented to another ACPM circuit at a next level up (e.g., from the circuit 106a up to the circuit 104a). The signal STATUS provides information about the actual power being consumed that is under the control of each respective ACPM circuit.

The circuits 106a-106n actively manage the current (or power) profile for one or many circuits 94. The management is based on a current consumption target that is either (i) preset or (ii) actively set via the signal TARGET by an ACPM circuit in the next higher hierarchical level.

The circuits 104a-104d aggregate current (or power) consumption information from the circuits 106a-106n. The circuits 104a-104d are operational to make decisions on, and set current consumption targets for the circuits 106a-106n based on the status information received via the signal STATUS from the circuits 106a-106n. The circuits 104a-104d are also operational to a preset target consumption and/or an active target consumption set via the signal TARGET from the circuit 102 and/or the signal SYS from the circuits 92. Is some embodiments, the one or more circuits 1061-106n may be merged with a corresponding one of the circuits 104a-104d. As such, the signal SYS may be transmitted and/or received by at the LACPM level.

The circuit 102 aggregates current (or power) consumption information from the circuits 104a-104d. The circuit 102 is operational to make decisions on, and set current consumption targets for the circuits 104a-104d based on the status information received via the signal STATUS from the circuits 104a-104d. The circuit 102 is also operational to present target consumption and/or an active target consumption set by the circuits 92 via the signal SYS.

In some embodiments, adjustments of the power consumption profile to ease the filtering criteria of the circuits 96 include one or more of the following techniques where applicable. In one technique, one or more of the circuits 94 are activated by the corresponding circuits 106a-106n from a low-power consumption (e.g., idle or sleep) mode into a high-power (or high-current) consumption (or active) mode when some of the circuits 94 are in the low-power (or low current) consumption mode. In another technique, an approximately constant current consumption of a given one of the circuits 94 (e.g., circuit 94a) is maintained. For example, the given circuit 94a is controlled by the circuit 106a to remain in the high-power consumption mode always even when the high-power consumption mode is not utilized by the system functionality. By remaining in the high-power consumption mode, the circuit 94a does not generate large low-frequency variations in the power being consumed. The lack of low-frequency variations makes it easier for the circuits 96 to filter the electrical power. In still another technique where the circuit 94a performs multiple operations, the circuit 106a can ramp up and ramp down the power consumed by selectively enabling and disabling various operations within the circuit 94a at different times. For example, if the circuit 94a implements a content addressable memory, the circuit 106a may increase/decrease the number of parallel comparisons performed for a search or increase/decrease the number of searches over a period time to increase/decrease the overall power consumption of the circuit 94a.

In some embodiments, a power noise processor of the circuits 106a-106n, 104a-104d and/or 102 looks at a history of current consumption and incoming functional requests from the circuits 92 to decide whether to put some circuits 94 into the high-power (or high-current) consumption mode or the low-power (or low-current) consumption mode. A goal of the decision is to create the least amount of power noise but still honor the functional requests. In some embodiments of the invention, the circuits 92 can tolerate some cycles of latency. Therefore, the power noise processor can factor in predicted future current consumptions based on the functional requests to decide which mode(s) the circuits 94 should be in for a next cycle. In some embodiments of the invention, the power noise processor can also move functional requests around in time to further help reduce the power noise generated by changes in the power consumption of the circuits 94.

Another technique for controlling the power consumption profile is to ramp up and/or ramp down the power consumption of the circuits 94. Ramping up from idle to the high-power consumption mode and/or ramping down to idle avoids step impulses and so slower current profile disturbances. The ramp rates and durations can be programmable by ramping the target circuits 106a-106n.

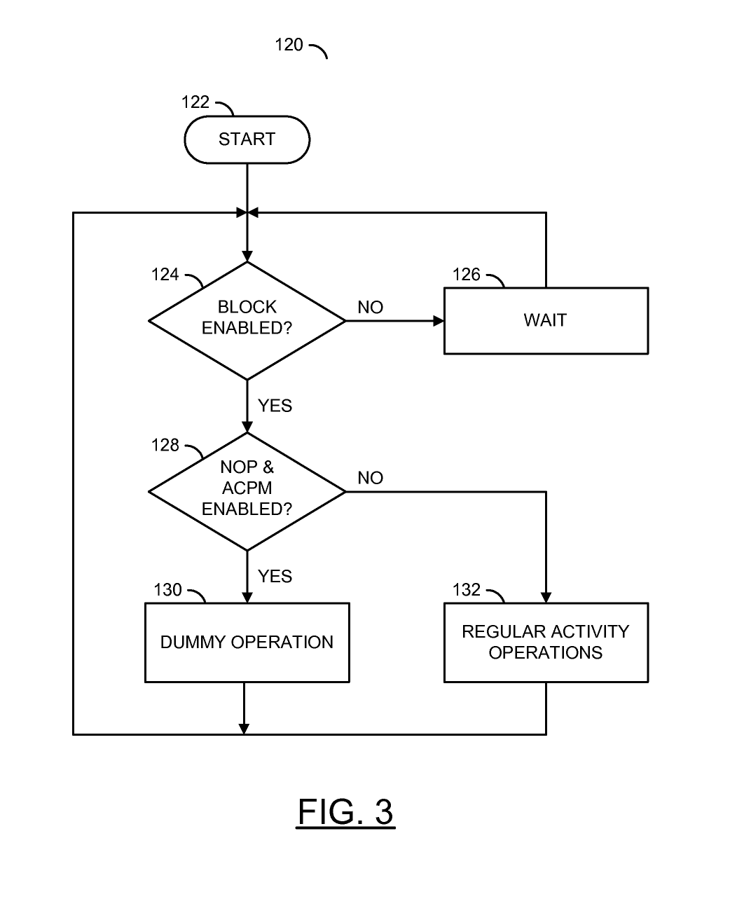

Referring to FIG. 3, a flow diagram of a method embodiment 120 for adjusting a power consumption profile is shown. The method (or process) 120 is implemented by the circuit 100. The method 120 comprises a step (or state) 122, a step (or state) 124, a step (or state) 126, a step (or state) 128, a step (or state) 130 and a step (or state) 132. The steps 122 to 132 may represent modules and/or blocks that may be implemented as hardware, software, a combination of hardware and software, or other implementations.

The method 120 starts at an initial condition in the step 122. In the step 124, one of the circuits 106a-106n (e.g., the circuit 106a) checks to see if one of the wrapped circuits 94 (e.g., the circuit 94a) is enabled. If not, the circuit 106a waits in the step 126 for a next cycle of the system 90 and then checks the circuit 94a again for enablement.

A check is shown being made by the circuit 106a in the step 128 to determine (i) if profile control is enabled and (ii) if the circuit 94a has any normal (or active) operations to perform. If there are no normal operations and the circuit 106a is enabled for active profile control, the circuit 106a instructs the circuit 94a to perform at least one dummy operation in the step 130. By performing the dummy operations, the power consumed by the circuit 94a is maintained at a value consistent with the power consumed while performing normal operations. Therefore, the power consumed by the circuit 94a remains virtually constant regardless of the performance or nonperformance of useful work. After the dummy operations have been executed (or completed) by the circuit 94a, the method 120 returns to the step 124.

If the check at the step 128 determines that active profile control in the circuit 106a is disabled and/or the circuit 94a has at least one normal operation to perform, the circuit 94a performs the normal operation in the step 132. After the normal operations have been executed (or completed) by the circuit 94a, the method 120 returns to the step 124.

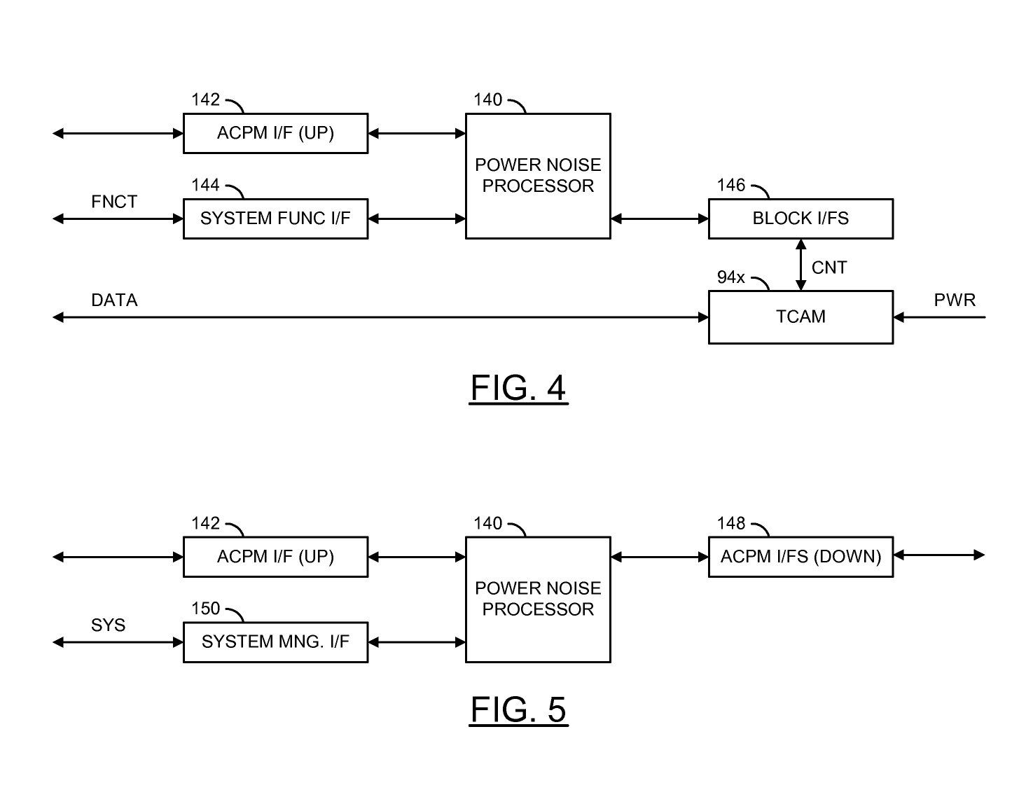

Referring to FIG. 4, a block diagram of an example implementation of an LACPM circuit is shown. An example implementation of a circuit 94 as a ternary content addressable memory 94x is also shown. The LACPM circuit illustrated is shown representative of the circuits 106a-106n. The LACPM circuit comprises a block (or circuit) 140, a block (or circuit) 142, a block (or circuit) 144 and a block (or circuit) 146. The circuits 140 to 146 may represent modules and/or blocks that may be implemented as hardware, software, a combination of hardware and software, or other implementations.

The signal FNCT is shown being sent and received by the circuit 144. The signal CNT is shown being sent and received by the circuit 146. The circuit 142 communicates the signals TARGET and STATUS with an SACPM circuit (e.g., the circuit 104a). The circuit 140 has internal bidirectional communications with each circuit 142-146.

The circuit 140 implements the power noise processor circuit. The circuit 140 is operational to control and monitor the power consumed by the one or more circuits 94 connected via the circuit 146. The controlling and monitoring reduces the power noise generated by the connected circuits 94. The controlling includes, but is not limited to, adjusting the connected circuits 94 and/or individual operations within the connected circuits 94 from the low-power consumption mode to the high-power consumption mode, from the high-power consumption mode to the low-power consumption mode, ramping up the power consumption, ramping down the power consumption and holding the power consumption at a constant level. The circuit 140 can be implemented in many forms, depending on where the circuit 140 sits in the hierarchy and which current profile management techniques are used.

Adjustments to the power consumptions are based on, but not limited to, present power allocations and power allocations received in the signal TARGET. In some embodiments, the adjustments are also based on a history of past power consumptions and predictions of future power consumptions based on system functional requests received via the signal FNCT.

The circuit 140 also monitors the status of the power being consumed and reports the data in the signal STATUS. The monitor status is based on, but is not limited to, the number of connected circuits 94 and/or individual operations within the circuits 94 in the low-power consumption mode and the high-power consumption mode. In some embodiments, the status information includes preset current values for each mode of each connected circuit 94 and each individually controlled operation. In other embodiments, the status information includes actual current values reported by the connected circuits 94, through the circuit 146, and to the circuit 140.

The circuit 142 implements an ACPM interface (e.g., I/F) circuit. The circuit 142 is operational to provide bidirectional communication between the circuit 140 and a SACPM circuit (e.g., the circuits 102 and 104a-104d). The circuit 142 encodes and transmits the signal STATUS. The circuit 142 receives and decodes the signal TARGET.

The circuit 144 implements a system functional interface. The circuit 144 is operational to provide bidirectional communication between the circuit 140 and the circuits 92. In some embodiments, the circuit 144 relays system functional requests from the circuits 92 to the circuit 140.

The circuit 146 implements a block interface circuit. The circuit 146 is operational to provide the wrapper interface functionality used to communicate between the circuit 140 and the connected circuits 94. The circuit 146 generates control information and data in the signal CNT presented to the connected circuits 94 (e.g., the circuit 94x). For example, the circuit 146 presents commands for the circuit 94x to perform a search on a dummy search word also presented by the circuit 146. In another example, the circuit 146 presents commands for the circuit 94x to perform a dummy read of any one or more search terms stored in the circuit 94x. The circuit 146 also receives acknowledgment information and data in the signal CNT from the connected circuits 94. For example, the circuit 146 receives an acknowledgment indication from the circuit 94x that the search has been completed and receives data identifying where the dummy search word was found.

Referring to FIG. 5, a block diagram of an example implementation of an SACPM circuit is shown. The SACPM circuit illustrated is representative of the circuits 104a-104d and the circuit 102. The SACPM circuit comprises the circuit 140, the circuit 142, a block (or circuit) 148 and a block (or circuit) 150. The circuits 140 to 150 may represent modules and/or blocks that may be implemented as hardware, software, a combination of hardware and software, or other implementations.

The circuit 140 implements the power noise processor circuit. In some embodiments, the circuit 140 of the SACPM circuits has the same design as the circuit 140 of the LACPM circuits. In other embodiments, the circuit 140 of the SACPM circuits has a different design than the circuit 140 of the LACPM circuits.

The circuit 148 implements another ACPM interface circuit. The circuit 148 is operational to provide bidirectional communication between the circuit 140 and an SACPM circuit (e.g., the circuits 104a-104d) or an LACPM circuit (e.g., the circuits 106a-106n) The circuit 148 encodes and transmits the signal STATUS. The circuit 148 receives and decodes the signal TARGET. In some embodiments, the circuit 148 has the same design as the circuit 142. In other embodiments, the circuit 148 has a different design than the circuit 142.

The circuit 150 implements a system management interface circuit. The circuit 150 is operational to provide bidirectional communication between the circuit 140 and the circuits 92. In some embodiments, the circuit 150 relays system management data from the circuits 92 to the circuit 140.

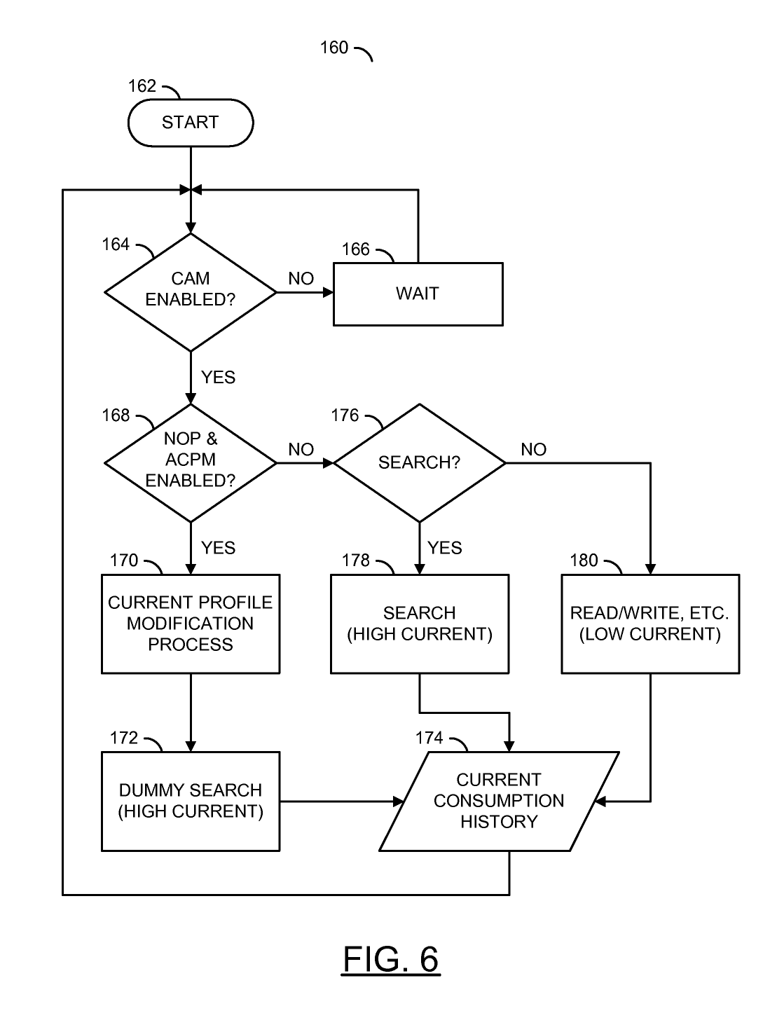

Referring to FIG. 6, a flow diagram of another example method 160 for adjusting a power consumption profile is shown. The method (or process) 160 is implemented by the circuit 100. The method 160 comprises a step (or state) 162, a step (or state) 164, a step (or state) 166, a step (or state) 168, a step (or state) 170, a step (or state) 172, a step (or state) 174, a step (or state) 176, a step (or state) 178 and a step (or state) 180. The steps 162 to 180 may represent modules and/or blocks that may be implemented as hardware, software, a combination of hardware and software, or other implementations. The example as shown is based on the power noise processor circuit 140 and the TCAM circuit 94x illustrated in FIG. 4.

The method 160 starts at an initial condition in the step 162. In the step 164, the circuit 140 checks to see if the circuit 94x is enabled. If not, the circuit 140 waits in the step 166 for a next cycle of the system 90 and then checks the circuit 94x again for enablement.

A check is shown being made by the circuit 140 in the step 168 to determine (i) if profile control is enabled and (ii) if the circuit 94x has any normal (or active) operations to perform. If there are no normal operations and the circuit 140 is enabled for active profile control, the circuit 140 performs a current profile modification process in the step 170 based on a history of the power consumed. Based on the results of the current profile modification process, the circuit 140 may or may not instruct the circuit 94x (or another of the circuits 94) to perform dummy search operation in the step 172 to achieve an appropriate current profile. In the step 174, the circuit 140 records the current power consumption, for instance, circuit 140 may contain linear filters or finite impulse response filters that convert power consumption history into digital value or a set of values. In some embodiments, the history is shown passed up in the hierarchy via the signal STATUS. After the step 172 has been executed (or completed) by the circuit 94x, the method 160 returns to the step 164.

If the check at the step 168 determines that active profile control in the circuit 140 is disabled and/or the circuit 94x has at least one normal operation to perform, a check is shown being performed by the circuit 140 in the step 176 to determine what type of normal operation has been requested. If the normal operation is a high-current operation (e.g., a normal search operation), the circuit 140 enables the circuit 94x to perform the high-current operation in the step 178. If the requested operation is a low-current operation (e.g., a normal read, normal write, etc.), the circuit 140 enables the circuit 94x to perform the low-current operation in the step 180. During or after the normal operation is performed by the circuit 94x, the circuit 140 adds the power consumption of the normal operation to the history in the step 174. After that, the method 160 returns to the step 164.

In some embodiments, one or more circuits 100 can manage a group of individual circuits 94, or the apparatus 90 as a whole, to achieve low overall current consumption fluctuations. The low-current consumption fluctuations are achieved by dynamically assigning current consumption modes for each individual circuit 94. The profile management in such cases is achieved by using one or more approaches.

In some embodiments, the circuits 104a-140d monitor and align high-to-low current consumption transitions and low-to high-current consumption transitions to proximity in time. For instance, the circuits 104a-104d can delay timing of when a circuit (e.g., a memory circuit) goes into a sleep mode so that the reduced current consumption would align when another circuit 94 (e.g., another memory circuit) wakes up from the sleep mode.

In other embodiments, the ramp-up function could take advantage of grouping several independently controllable circuits 94 and/or operations (or sub-circuits). For example, the circuits 104a-104d and 106a-106n implement ramping by gradually enabling more individual circuits 94 into the high-power consumption mode over time to avoid a sharp change in current. The gradual enabling is done by the circuits 104a-104d dynamically changing the target power consumption for each group of the circuits 106a-106n.

In still other embodiments, a guarantee exists that at most a certain percentage of the circuits 94 in a particular group will be in the high-power consumption mode. The circuits 104a-140d and/or 106a-106n use an amount of current consumption with the certain percentage as the constant to be maintain. For example, at most 1 out of 8 individual circuits 94 can be in the high-power consumption mode, as guaranteed by the system. Therefore, the circuits 104a-104d and/or 106a-106n place any 1 block in the high-power consumption mode if there is no system functional request. Otherwise, a specific circuit 94 requested by circuits 92 is placed in the high-power consumption mode. Thus, the percentage of the circuits 94 in the high-power consumption mode is kept at 12.5 percent at all times.

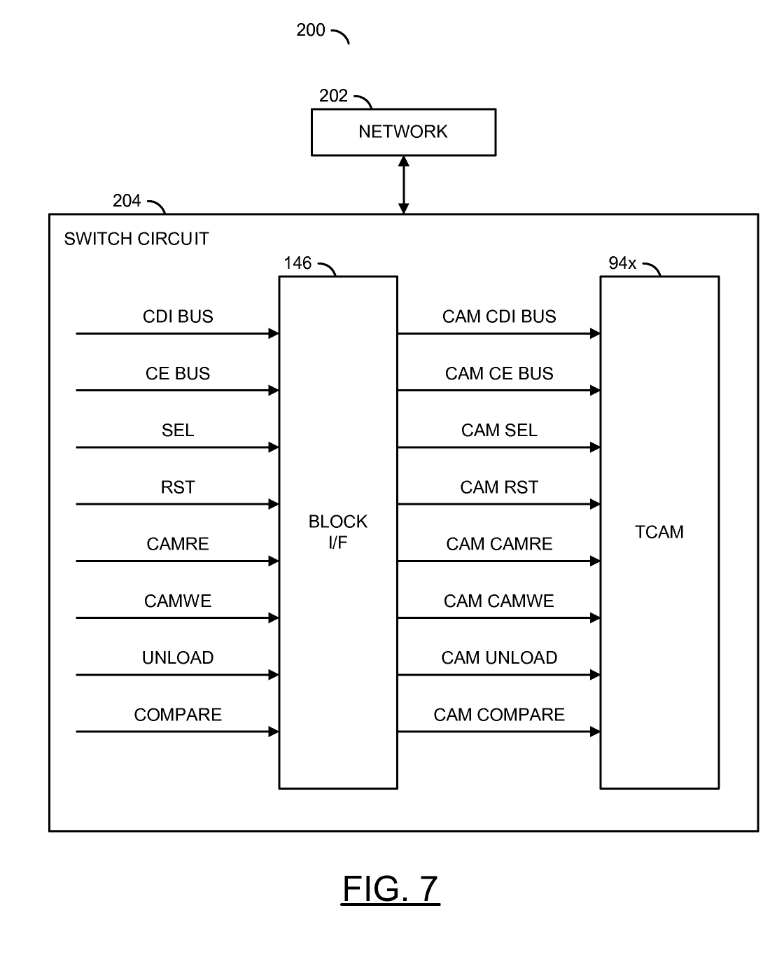

Referring to FIG. 7, a block diagram of an example implementation of a digital switching system 200 implementing the active current profile management is shown. The system (or apparatus) 200 comprises a block (or circuit) 202 and a block (or circuit) 204. The circuits 202 to 204 may represent modules and/or blocks that may be implemented as hardware, software, a combination of hardware and software, or other implementations.

The circuit 202 implements a digital network. The circuit 202 is operational to carry digital data among multiple nodes of the network. The data is typically arranged in one or more packets. Each set of packets contains a destination address for where the packet is being sent. As the set of packets passes through a switch circuit in the network, the destination address is examined to determine along which of several possible paths the packets should be sent. The determination is often made by a content addressable memory that can search for the destination address to find the next path in the network 202.

The circuit 204 implements a switch circuit. The circuit 204 is operational to route the packets from an incoming path to an outgoing path based on the destination address. The circuit 204 comprises the circuits 92 to 150.

The circuit 146 within the circuit 204 is shown implemented as a block interface circuit to a ternary CAM circuit. The circuit 94x is shown implemented as the ternary CAM. The circuit 146 receives a set of signals including, but not limited to, a data input signal (e.g., CDI BUS), a chip enable signal (e.g., CE BUS), a select signal (e.g., SEL), a reset signal (e.g., RST), a read enable control signal (e.g., CAMRE), a write enable control signal (e.g., CAMWE), a deactivate signal (e.g., UNLOAD) and a compare signal (e.g., COMPARE). The circuit 146 generates and presents a set of signals to the circuit 94x. The presented signals include, but are not limited to, a data input signal (e.g., CAM CDI BUS), a chip enable signal (e.g., CAM CE BUS), a select signal (e.g., CAM SEL), a reset signal (e.g., CAM RST), a read enable control signal (e.g., CAM CAMRE), a write enable control signal (e.g., CAM CAMWE), a deactivate signal (e.g., CAM UNLOAD) and a compare signal (e.g., CAM COMPARE).

In some embodiments, the circuit 146 is used to control the circuit 94x such that the power consumption of the circuit 94x is maintained at a constant level. For example, the circuit 146 can present a dummy search word to the circuit 94x in the signal CAM CDI BUS. The circuit 146 can subsequently assert the signal COMPARE to cause the circuit 94x to perform a search (e.g., a high-current operation). By repeatedly asserting the signal COMPARE, the circuit 146 can keep the power consumption profile of the circuit 94x approximately constant over any given schedule.

The functions performed by the diagrams of FIGS. 1-7 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

Embodiments of the invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

Embodiments of the invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of embodiments of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

Although embodiments of the invention have been described herein with reference to the accompanying drawings, it is to be understood that embodiments of the invention are not limited to the described embodiments, and that various changes and modifications may be made by one skilled in the art resulting in other embodiments of the invention within the scope of the following claims.

1. An apparatus comprising:
one or more of a plurality of circuits in a first level of a hierarchy; and
two or more of said circuits in a second level of said hierarchy, wherein said circuits are configured to (i) allocate a profile from said first level down to said second level, (ii) manage from said second level a respective power consumed by each of a plurality of blocks based on said profile and (iii) maintain a sum of said powers approximately constant by increasing said power consumed by a first of said blocks while decreasing said power consumed by a second of said blocks.

2. The apparatus according to claim 1, wherein said increasing of said power consumed by said first block comprises repeatedly performing a dummy operation in said first block while said first block has none among one or more normal operations to perform.

3. The apparatus according to claim 2, wherein at least one of said circuits is further configured to stop said dummy operation in said first block while said first block has at least one of said normal operations to perform.

4. The apparatus according to claim 2, wherein at least one of said circuits is further configured to stop said dummy operation in said first block while increasing said power consumed by a third of said blocks.

5. The apparatus according to claim 1, wherein said circuits are further configured to report a status of said power consumed by said blocks from said second level up to said first level in said hierarchy of said circuits.

6. The apparatus according to claim 1, wherein at least one of said circuits is further configured to store a history of said power consumed by said first block.

7. The apparatus according to claim 6, wherein said managing of said power of said first block is based on said history.

8. The apparatus according to claim 1, wherein at least one of said blocks comprises a ternary content addressable memory managed to maintain consumption of said power approximately constant by repeatedly performing a search.

9. The apparatus according to claim 1, wherein control of said powers is based on a consumption history and a predicted future consumption.

10. The apparatus according to claim 1, wherein said apparatus is implemented as one or more integrated circuits.

11. A method for power integrity control through active current profile management, comprising the steps of:
(A) allocating a profile from a first level down to a second level in a hierarchy of circuits;
(B) managing from said second level a respective power consumed by each of a plurality of blocks based on said profile; and
(C) maintaining a sum of said powers approximately constant by increasing said power consumed by a first of said blocks while decreasing said power consumed by a second of said blocks.

12. The method according to claim 11, wherein said increasing of said power consumed by said first block comprises repeatedly performing a dummy operation in said first block while said first block has none among one or more normal operations to perform.

13. The method according to claim 12, further comprising the step of:
stopping said dummy operation in said first block while said first block has at least one of said normal operations to perform.

14. The method according to claim 12, further comprising the step of:
stopping said dummy operation in said first block while increasing said power consumed by a third of said blocks.

15. The method according to claim 11, further comprising the step of:
reporting a status of said power consumed by said blocks from said second level up to said first level in said hierarchy of said circuits.

16. The method according to claim 11, further comprising the step of:
storing a history of said power consumed by said first block.

17. The method according to claim 16, wherein said managing of said power of said first block is based on said history.

18. The method according to claim 11, wherein at least one of said blocks comprises a ternary content addressable memory managed to maintain consumption of said power approximately constant by repeatedly performing a search.

19. The method according to claim 11, wherein control of said powers is based on a consumption history and a predicted future consumption.

20. An apparatus comprising:
means for allocating a profile from a first level down to a second level in a hierarchy of circuits;
means for managing from said second level a respective power consumed by each of a plurality of blocks based on said profile; and
means for maintaining a sum of said powers approximately constant by increasing said power consumed by a first of said blocks while decreasing said power consumed by a second of said blocks.
